(19) United States
(12) Patent Application Publication
(10) Pub. No.: US 2012/0293480 A1
(43) Pub. Date: Nov. 22, 2012

(54) ELECTROPHORETIC DISPLAY AND RELATED DRIVING METHOD

(76) Inventors: Feng-Sheng Lin, Hsin-Chu (TW); Kuo-Hsing Cheng, Hsin-Chu (TW); Chun-Chi Lai, Hsin-Chu (TW); Ching-Yen Tsai, Hsin-Chu (TW)

(21) Appl. No.: 13/441,929

(22) Filed: Apr. 9, 2012

(30) Foreign Application Priority Data
May 17, 2011 (TW) 100117217

(51) Int. Cl. G09G 3/34; G06F 3/038

(52) U.S. Cl. 345/212; 345/107

(57) ABSTRACT

An electrophoretic display and a related driving method are provided, the electrophoretic display and related driving method for causing voltage level switching of a common signal of the electrophoretic display, which induces colored electrophoretic particles to be arranged in a more compact way during a power-off period, thereby improving the quality of a standby image of the electrophoretic display.

### BACKGROUND

1. Technical Field

The present invention relates generally to electrophoretic display technology, and more particularly to an electrophoretic display and a related driving method that improves the quality of a standby image during a power-off period by switching the voltage level of a common signal.

2. Description of the Related Art

Electrophoretic display technology is a major display technology used by electronic reading devices. The thickness of an electrophoretic display is very close to the thickness of paper, and has the additional advantages of low power consumption, high contrast, wide viewing angle and extreme elasticity. Electrophoretic display technology uses voltages to control charged pigment particles spread in a liquid dielectric material. The charged pigment particles will move within the liquid dielectric material, due to these driving voltages and, depending on the movement of the charged pigment particles, pixels will become lighter or darker, thereby achieving different visual effects.

Please refer to FIG. 1, which illustrates a constructional drawing of an electrophoretic display. A displaying area of the electrophoretic display 100 consists of a plurality of pixels 5, each of which includes an electrophoretic element 10 consisting of dielectric material 11 and charged pigment particles P. A transparent common electrode 12 is disposed above the electrophoretic elements 10 and an adhesive layer 13 is disposed below the electrophoretic elements 10. A data electrode 14 is disposed below each electrophoretic element 10. The common electrode 12 is employed for applying a common signal V_{COM} generated by the common signal generation device 16 to the electrophoretic element 10. The data electrode 14 is employed for applying a data signal V_{DATA} generated by the data signal generation device 18 to the electrophoretic element 10. A voltage potential difference between the common electrode 12 and the data electrode 14 will form an electric field of a specific direction surrounding the electrophoretic element 10 which causes the charged pigment particles P in the electrophoretic element 10 to move. This allows images displayed on the electrophoretic display 100 to change.

During a power-off period of the electrophoretic display 100, a default standby image will be shown (e.g. a white image or an image including a trademark). It is required to drive the electrophoretic element 10 during a period prior to the power-off period such that the arrangement of the charged pigment particles P visually emerges as the standby image. When the internal power supply of the electrophoretic display 100 is removed, the common electrode 12 and the data electrode 14 both enter a high impedance state (hi-Z state) to maintain the arrangement of the charged pigment particles P. As there is no voltage potential difference between the common electrode 12 and the data electrode 14 at this moment, the electric field surrounding the electrophoretic element 10 disappears. The arrangement of the charged pigment particles P will therefore be easily affected or destructed by gravity (as shown in FIG. 2).

### SUMMARY

With this in mind, it is one objective of the present invention to provide an electrophoretic display and a driving method. The concept of the present invention is to switch voltage levels of the common signal to make a compact arrangement of charged pigment particles instead of switching voltage levels of the data signal.

According to one exemplary embodiment of the present invention, an electrophoretic display is provided. The electrophoretic display comprises: a data electrode, a common electrode, an electrophoretic element, a data signal generation device and a common signal generation device. The electrophoretic element is disposed between the data electrode and the common electrode. The data signal generation device is coupled to the data electrode, and employed for outputting a data signal to the data electrode. The common signal generation device is coupled to the common electrode, and employed for outputting a common signal to the common electrode, wherein the common signal has a plurality of voltage levels. The controller is respectively coupled to the data signal generation device and the common signal generation device. During a specific period, the controller controls the data signal generation device to maintain the data signal at a specific voltage level, and controls the common signal generation device to make the common signal alternately switch among a plurality of first specific voltage levels of the voltage levels.

According to another exemplary embodiment of the present invention, a driving method of driving an electrophoretic display is provided. The electrophoretic display includes an electrophoretic element. The electrophoretic element is disposed between a data electrode and a common electrode. The method comprises: providing a data signal to the data electrode; providing a common signal to the common electrode, wherein the common signal has a plurality of voltage levels; and during a specific period, controlling the data signal to maintain at a specific voltage level, and controlling the common signal to alternately switch among first specific voltage levels of the voltage levels.

The inventive driving method and display can reduce potential risks of damaging circuits of the display due to voltage level switching on the data electrode. The present invention also reduces the power consumption of signal generation circuits of the display. This is because the common electrodes required in the electrophoretic display are fewer than the data electrodes, so utilizing the common electrode to perform voltage switching will lead to reduced power consumption and reduced circuit complexity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a constructional diagram of an electrophoretic display in the conventional art.

FIG. 2 illustrates the changing arrangement of charged pigment particles of an electrophoretic display.

FIG. 3 is a constructional diagram of an electrophoretic display according to one exemplary embodiment of the present invention.

FIG. 4 illustrates waveforms of a common signal and a data signal according to one exemplary embodiment of the present invention.

FIG. 5 illustrates waveforms of the common signal and the data signal according to another exemplary embodiment of the present invention.

FIGS. 6 and 7 illustrate waveforms of the common signal and the data signal according to other exemplary embodiments of the present invention.

FIG. 8 is a circuit diagram of a common signal generation device according to one exemplary embodiment of the present invention.

FIG. 9 is a flow chart of a driving method according to one exemplary embodiment of the present invention.

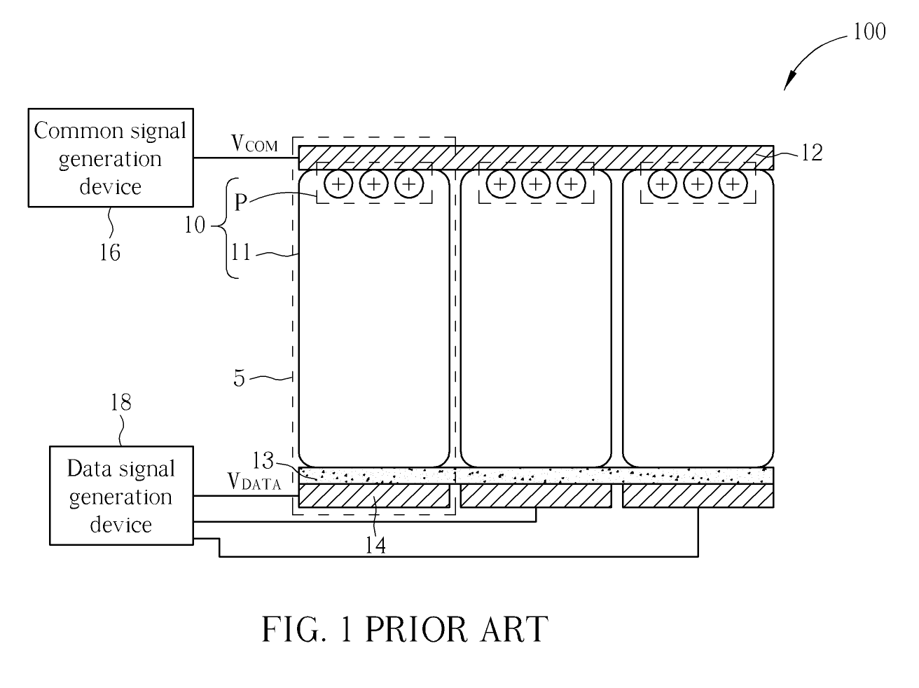

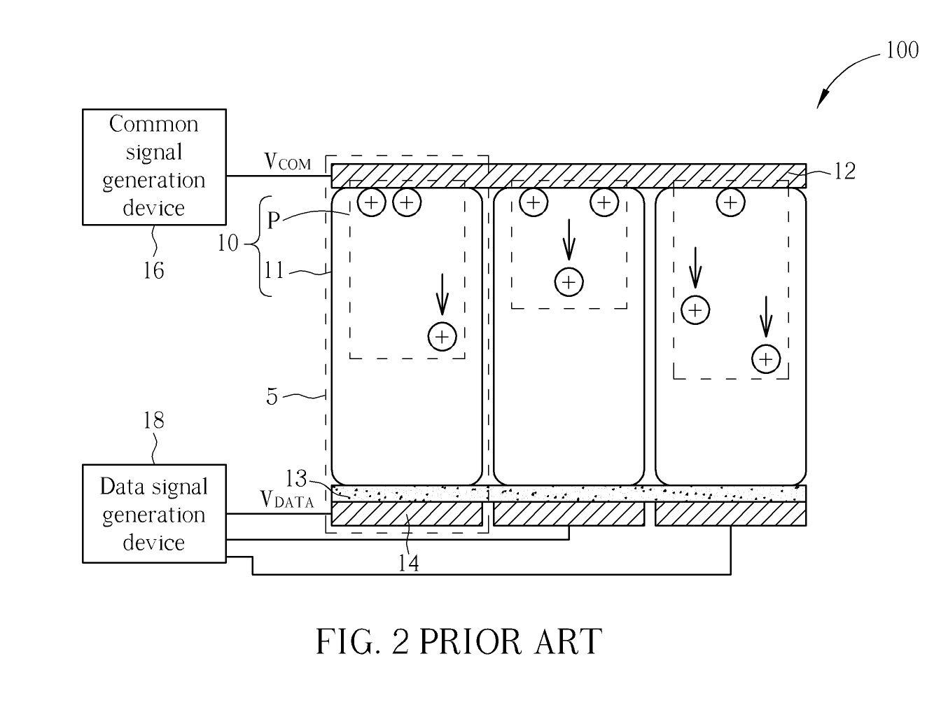

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

In the specification, the invention will be described with reference to specific exemplary embodiments thereof; however, it will be evident that various modifications and changes may be made thereto without departing from the broader spirit and scope of the invention as set forth in the following claims. Accordingly, the specification and drawings are to be regarded in an illustrative sense rather than a restrictive sense.

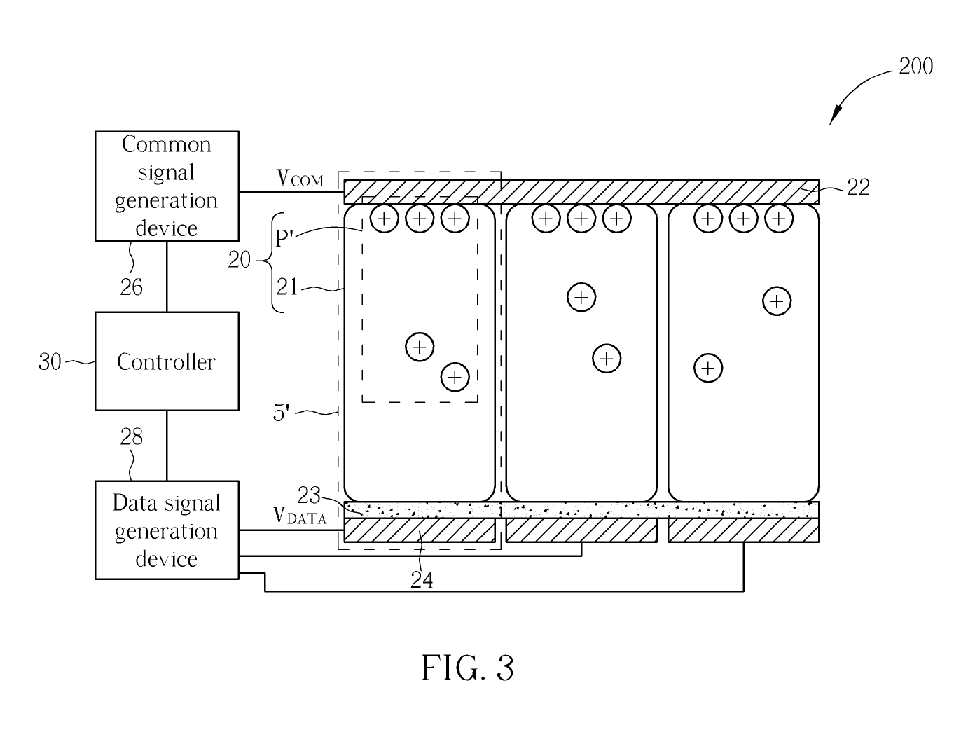

With reference to FIG. 3, a constructional diagram of an inventive electrophoretic display is schematically according to one exemplary embodiment. Please note that only part of the structure of the electrophoretic display is illustrated. The display area of the electrophoretic display 200 includes a plurality of pixels 5′, and each pixel 5′ has an electrophoretic element 20, wherein the electrophoretic element 20 comprises at least dielectric material 21 and charged pigment particles P′ 20. Please note that, although the charged pigment particles P′ are represented by white positively charged particles, in various embodiments of the present invention, the charged pigment particles P′ may comprise particles having different colors or be oppositely charged (e.g. black negatively charged particles). Furthermore, although only structures and components related to the spirit of the invention are mentioned and explained in the specification, this should not be considered as limitations of the invention. The electrophoretic element 20 may comprise other components.

A transparent common electrode 22 is disposed above the upper part of the electrophoretic element 20 and an adhesive layer 23 is disposed below the electrophoretic element 20. Below the adhesive layer 23, a data electrode 24 is disposed at each electrophoretic element 20. The common electrode 22 is employed for applying a common signal V_{COM} that is generated by a common signal generation device 26 to the electrophoretic element 20. The data electrode 24 is employed for applying the data signal V_{DATA} that is generated by a data signal generation device 28 to the electrophoretic element 20. Please note that the process of applying the data signal V_{DATA} also involves scan-line driving technology and related circuits in order to correctly control the timing when the pixel 5′ is driven. As scan-line driving technology is well-known to those of ordinary skill in the art, detailed descriptions are omitted here for the sake of brevity.

A voltage potential difference between the common electrode 22 and the data electrode 24 can cause an electric field having a specific direction to be formed surrounding the electrophoretic element 20, thereby allowing the charged pigment particles P′ to move, for different visual effects. The controller 30 is respectively coupled to the data signal generation device 28 and the common signal generation device 26. During a specific period Period_X, the controller 30 controls the data signal generation device 28 to maintain the data signal V_{DATA} at a specific voltage level, and simultaneously controls the common signal generation device 26, to make the common signal V_{COM} alternate between a plurality of voltage levels VL_1˜VL_M of a plurality of voltage levels VL_1˜VL_N, wherein N is greater than or equal to M. The switching of the voltage levels of the common signal V_{COM} and relationship between the voltage levels of the common signal V_{COM} and the data signal V_{DATA} are explained in detail as below.

The electrophoretic display may be driven in an alternate current (AC) manner or a direct current (DC) manner. Depending on the driving types of the electrophoretic display, the switching of the voltage levels of the common signal V_{COM} and the data signal V_{DATA} will also be different. The following paragraphs will respectively illustrate switching of the voltage levels for different driving types.

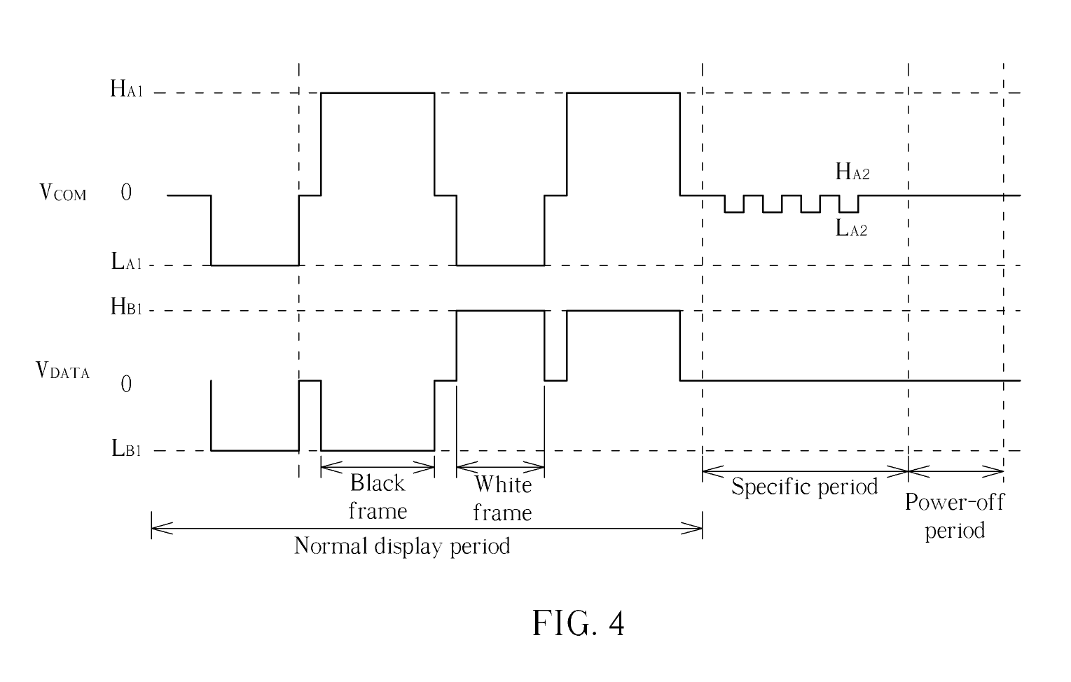

Please refer to FIG. 4, which illustrates waveforms of the common signal V_{COM} and the data signal V_{DATA} in accordance with one exemplary embodiment of the invention. This embodiment is related to the AC driving type. As shown, when the display 200 is operated during a normal display period Period_D, in order to generate an image having specific grey levels (e.g. a standby image), the common signal V_{COM} will be switched between a higher voltage level H_{A1} and a lower voltage level L_{A1}, and the data signal V_{DATA} will be switched between a higher voltage level H_{B1} and a lower voltage level L_{B1}, such that an image including specific grey levels will be shown on the display 200. When a power-off instruction is acknowledged, the electrophoretic display 200 will enter the specific period Period_X. At the same time, the controller 30 controls the data signal generation device 28 to maintain the data signal V_{DATA} at a voltage level (e.g. 0V), and also controls the common signal generation device 26 to make the common signal V_{COM} frequently switch between a higher voltage level H_{A2} and a lower voltage level L_{A2}. Afterwards, when the specific period Period_X ends, the electrophoretic display 200 will actually enter the power-off period. The common electrode 22 and the data electrode 24 will be controlled by the common signal generation device 26 and the data signal generation device 28, respectively, to enter the hi-Z state. During the power-off period, the common signal generation device 26 and the data signal generation device 28 will not provide voltage to the electrophoretic element 20. As a consequence, the image having the specific grey levels generated during the normal display period Period_D will last for the power-off period. Furthermore, because the switching of the voltage levels that is performed during the specific period Period_X causes the charged pigment particles P′ to be arranged more compactly, the arrangement of the charged pigment particles P′ has better persistence, guaranteeing the quality of the standby image.

One advantage of this embodiment is that the switching of the common signal V_{COM} is accomplished by a higher voltage level H_{A2} and a lower voltage level L_{A2} that are both smaller than the voltage levels used during the normal display period Period_D. As the power consumption is related to the voltage levels, compared to the switching of data signal V_{DATA} in the conventional art (i.e. the switching is performed between voltage levels that are identical to the voltage levels used in the normal display period Period_D), the present invention significantly reduces the power consumption. In addition, the common electrode 22 is generally a single electrode with a large area that provides the common voltage to many electrophoretic elements 20 of the electrophoretic display 200 simultaneously, meaning this embodiment, under certain circumstances, can use only one common signal generation device 26. Since each electrophoretic element 20 has a respective data electrode 24, the electrophoretic display 200 also needs to include many data signal generation devices 28 if each data signal generation device 28 is designed to provide the voltage levels for switching. In doing so, both the circuit complexity and the power consumption will be increased.

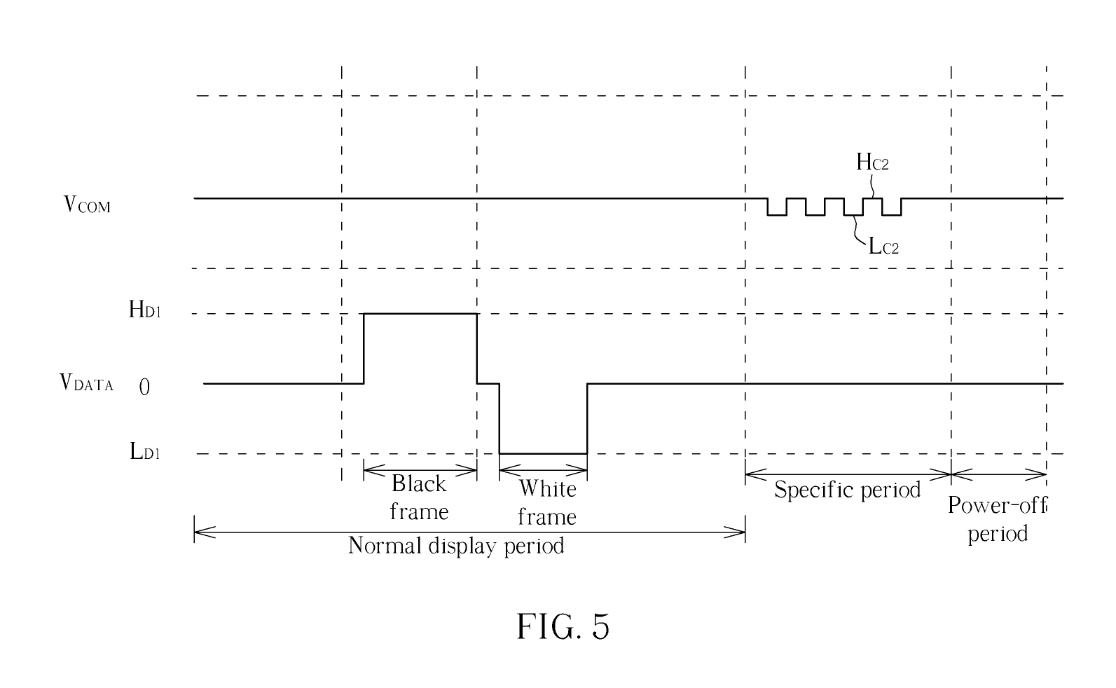

Please continue to refer to FIG. 5, which illustrates waveforms of the common signal V_{COM} and the data signal V_{DATA} according to one exemplary embodiment, which is related to a DC driving type. As shown, when the display 200 operates during the normal display period Period_D, the common signal V_{COM} is maintained at a specific voltage level while the data signal V_{DATA} switches between a higher voltage level H_{D1} and a voltage level L_{D1}. As there is a voltage potential difference between the common signal V_{COM} and the data signal V_{DATA}, colors of different grey levels can be formed by the electric field. When the power-off instruction is acknowledged, the display 200 enters the specific period Period_X. At the same time, the controller 300 controls the data signal generation device 28 to maintain the data signal V_{DATA} at a fixed voltage level (e.g. 0V) and simultaneously controls the common signal generation device 26, to make the common signal V_{COM} rapidly and frequently switch between a higher voltage level H_{C2} and a lower voltage level L_{C2}. Afterwards, when the specific period Period_X ends, the display 200 will enter the power-off period. At this time, the common electrode 22 and the data electrode 24 are both under the control of the common signal generation device 26 and the data signal generation device 28 when entering the hi-Z state. In this period, the common electrode 22 and the data electrode 24 will not provide any voltage to the electrophoretic element 20. Since the switching of the voltage performed during the specific period Period_X causes the charged pigment particles P′ to be arranged more compactly, the arrangement of the charged pigment particles P′ will have better persistence during the power-off period, which guarantees the quality of the standby image.

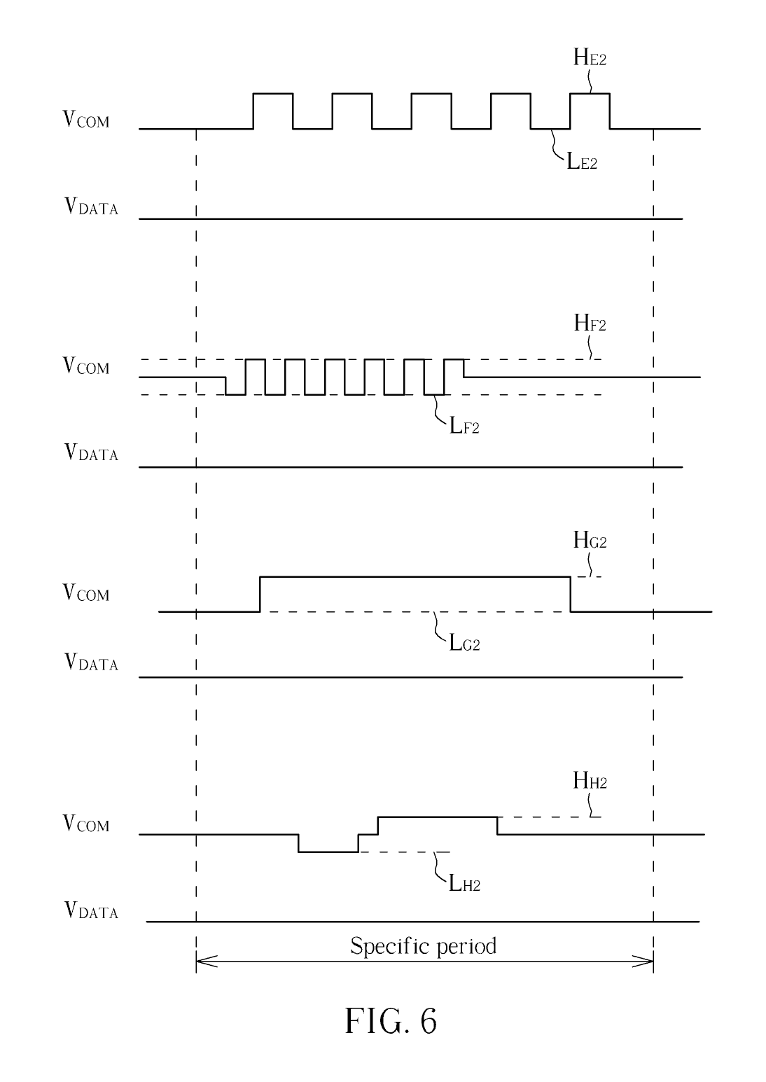

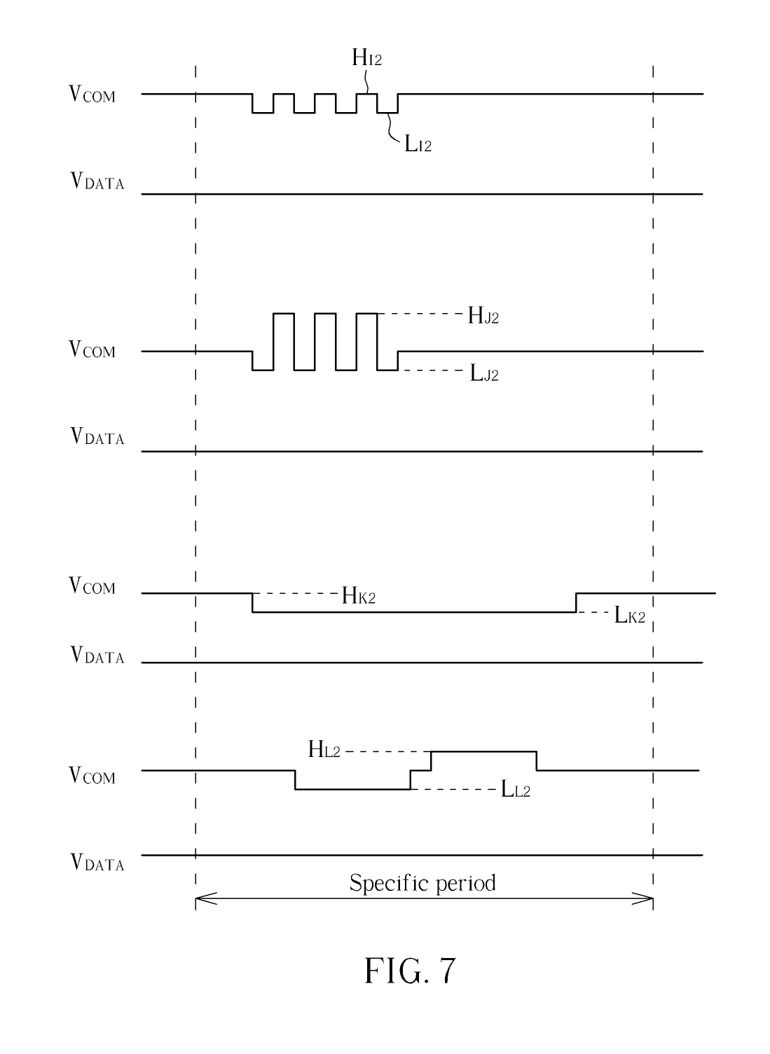

In addition to the driving types mentioned above, there are other driving types for the common signal V_{COM} and the data signal V_{DATA} according to other embodiments of the present invention. Please refer to FIG. 6 and FIG. 7. The two driving types illustrated in the top half of FIG. 6 are both intended to achieve the switching of the common signal V_{COM} for assuring the image quality. The difference between these two is DC balance. The first driving type does not reach DC balance while the second driving type does. In other words, for the first driving type, during the specific period Period_X, the higher voltage level HE2 and the lower voltage level L_{E2} may have only one polarity (both have the same polarity or one voltage level is zero), or have opposite polarities with different respective absolute values. For the second driving type, the higher voltage level H_{F2} and the lower voltage level L_{F2} have two different polarities (one being positive and the other being negative), and the absolute values of the voltage levels are the same.

Additionally, driving types illustrated in the bottom half of FIG. 6 can eliminate the DC offset generated during the normal display period Period_D. Taking the third driving type illustrated in FIG. 6 as an example, if during the normal display period Period_D, an electric field of a fixed direction is constantly applied to the electrophoretic element 20 for a long time, it will cause the characteristics of electrophoretic element 20 to be changed or even deteriorated. In order to avoid these influences, the common electrode V_{COM}provides a bias voltage in an opposite direction (e.g. a higher voltage level H_{G2}) for a certain period, to cancel the effect of the electric field. After the certain period ends, the common signal V_{COM} switches to the lower voltage level L_{G2}. In this embodiment, the higher voltage level H_{G2} and the lower voltage levelL_{G2} have only one polarity, or the higher voltage level H_{G2} and the lower voltage level L_{G2} have two different polarities but different absolute values: the common signal V_{COM} does not reach DC balance. The fourth driving type does reach DC balance, and the higher voltage level H_{H2} and the lower voltage level L_{H2} have two respective different polarities and have the same absolute values. FIG. 7 illustrates the relationship between waveforms of the common signal V_{COM} and the data signal V_{DATA} in accordance with various embodiments of the present invention. These embodiments can be in conjunction with either the AC driving type or the DC driving type. As illustrated, the higher voltage level H_{I2} and the voltage level L_{I2}, the higher voltage level H_{K2} and the voltage level L_{K2} do not reach DC balance. The higher voltage level H_{J2} and the lower voltage level L_{J2}, the higher voltage level H_{L2} and the voltage level L_{L2} do reach DC balance.

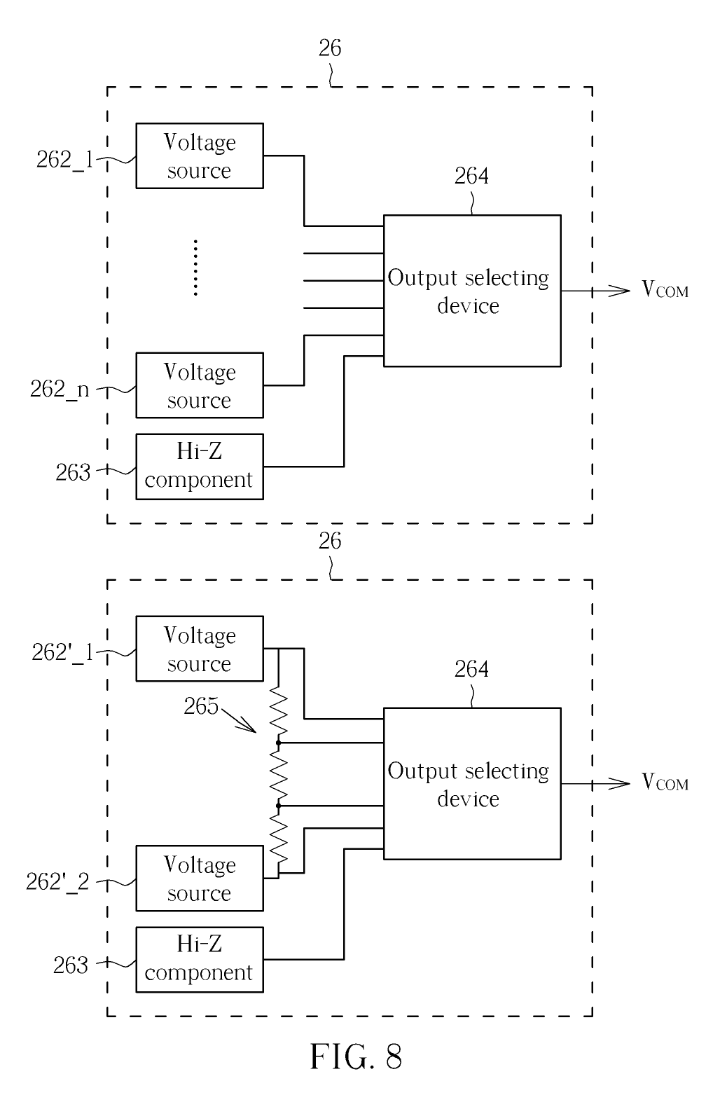

A possible implementation of the inventive common signal generation device 26 is illustrated in FIG. 8. As can be seen from the top half of FIG. 8, a plurality of voltage sources 262_1˜262_n are employed for providing different voltage levels and a hi-Z component 263 (for allowing the common electrode 22 to enter the hi-Z state during the power-off period). The output selecting device 264 are employed for selecting one of the voltage sources 262_1˜262_n to provide the common signal V_{COM}. The output selecting device 264 can be implemented with a selector, and used to determine the common signal V_{COM} according to the control signal of the controller 30 during different periods. As can be seen from the bottom half of FIG. 8, only two voltage sources 262′_1˜262′_2, a hi-Z component 263, and a voltage divider 265 are employed. With the voltage divider 265 (e.g. resistor ladder) dividing the voltage, the combination effect is equivalent to several different voltage sources. The output selecting device 264 accordingly determines the common signal V_{COM}. It should be noted that the actual implementation of the common signal generation device 26 is not restricted in scope to the implementation illustrated in FIG. 8. In fact, any signal generation device that is capable of providing a plurality of different voltage levels and selectively outputting one of the voltage levels can be used for implementing the common signal generation device 26.

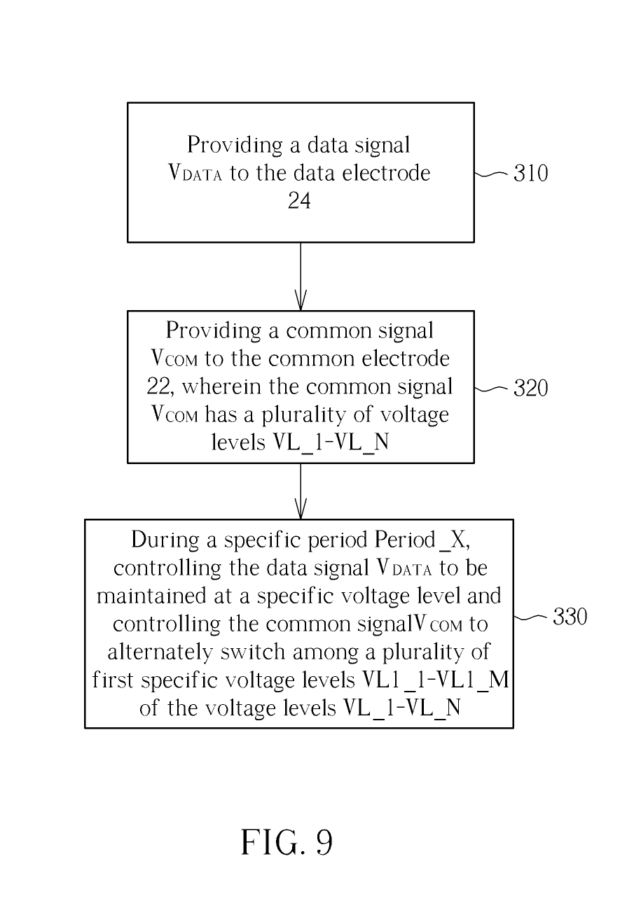

Regarding the inventive driving method, please refer to a flow chart illustrated in FIG. 9, which includes the following steps:

Step 310: providing a data signal V_{DATA} to the data electrode 24;

Step 320: providing a common signal V_{COM} to the common electrode 22, wherein the common signal V_{COM} has a plurality of voltage levels VL_1-VL_N; and

Step 330: during a specific period Period_X, controlling the data signal V_{DATA} to be maintained at a specific voltage level and controlling the common signalV_{COM} to alternately switch among a plurality of first specific voltage levels VL1_1 -VL1_M of the voltage levels VL_1-VL_N.

The specific period Period_X follows the normal display period Period_D. In addition, the inventive driving method further comprises: during a normal display period Period_D, controlling the common signal V_{COM} to alternately switch among a plurality of voltage levels VL2_1˜VL2_O of the voltage levels VL_1˜VL_N. At least one of the first specific voltage levels VL1_1˜VL1_M is different from the second specific voltage levels VL2_1˜VL2_O. Furthermore, the first specific voltage levels VL1_1˜VL1_M have at least one polarity (depending on whether DC balance is reached; if not, the first specific voltage levels may only have one polarity). The present invention uses different ways of switching the voltage levels of the common signal V_{COM} to obtain the stable standby image and to cancel the DC offset concurrently. In a preferred embodiment, the specific period Period_X is prior to a power-off period. During the power-off period, the inventive driving method allows the data electrode 22 and common electrode 24 to enter the hi-Z state.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter. For example, the first driving method illustrated in FIG. 6 can be combined with the third driving method therein. As such, during the specific period Period_X, the common signal V_{COM} will be switched rapidly and frequently. At the same time, it also serves as a bias voltage for cancelled DC offset. In short, any combination of the driving methods illustrated in FIG. 6 and/or FIG. 7 may be in various embodiments of the present invention.

The electrophoretic display and driving method of the present invention can be widely used in any types of displaying electronic devices, especially in electrical reading devices. Therefore, any electronic device which adopts the inventive electrophoretic display and/or the inventive driving method should fall within the scope the present invention.

In summary, the concept of the present invention is to switch the voltage level of the common signal that is applied to the common electrode. Such changing of the voltage level can cause the charged pigment particles to be arranged more compactly without affecting the standby image previously generated. Also, it is possible for the present invention to provide a stable bias voltage to cancel the DC offset generated during the previous display period. Hence, the standby image can be more stable during the power-off period. In addition, the switching of the common signal can avoid damage to the circuits caused by the switching of the data signal in the conventional manner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrophoretic display, comprising:
a data electrode;
a common electrode;
an electrophoretic element, disposed between the data electrode and the common electrode;
a data signal generation device, coupled to the data electrode, for outputting a data signal to the data electrode;
a common signal generation device, coupled to the common electrode, for outputting a common signal to the common electrode, wherein the common signal has a plurality of voltage levels; and
a controller, respectively coupled to the data signal generation device and the common signal generation device, wherein during a specific period, the controller controls the data signal generation device to maintain the data signal at a specific voltage level and controls the common signal generation device to make the common signal alternately switch between a plurality of first specific voltage levels of the voltage levels.

2. The electrophoretic display of claim 1, wherein the specific period follows a display period, and during the display period, the controller controls the common signal generation device to make the common signal alternately switch between a plurality of second specific voltage levels of the voltage levels, and at least one of the first specific voltage levels is different from the second specific voltage levels.

3. The electrophoretic display of claim 2, a voltage swing of the common signal during the specific period is smaller than a voltage swing of the common signal during the display period.

4. The electrophoretic display of claim 1, wherein the first specific voltage levels have at least one polarity.

5. The electrophoretic display of claim 1, wherein the specific period is prior to a power-off period.

6. The electrophoretic display of claim 5, wherein during the power-off period, the controller respectively controls output states of the data signal generation device and the common signal generation device to allow the data electrode and the common electrode to enter a high impendence state.

7. The electrophoretic display of claim 1, wherein the common signal generation device comprises:
a first voltage source;
a second voltage source; and
a voltage divider, coupled between the first voltage source and the second voltage source, for outputting at least one third voltage source;
wherein the voltage levels of the common signal are provided by the first voltage source, the second voltage source and the third voltage source, respectively.

8. An electronic device comprising the electrophoretic display of claim 1.

9. A method of driving an electrophoretic display, wherein the electrophoretic display includes an electrophoretic element, the electrophoretic element is disposed between a data electrode and a common electrode, and the method comprises:
providing a data signal to the data electrode;
providing a common signal to the common electrode, wherein the common signal has a plurality of voltage levels; and
during a specific period, controlling the data signal to maintain at a specific voltage level, and controlling the common signal to alternately switch between a plurality of first specific voltage levels of the voltage levels.

10. The method of claim 9, wherein the specific period follows a display period and the method further comprises:
during the display period, controlling the common signal to alternately switch between a plurality of second specific voltage levels of the voltage levels;
wherein at least one of the first specific voltage levels is different from the second specific voltage levels.

11. The method of claim 9, wherein the first specific voltage levels have at least one polarity.

12. The method of claim 9, wherein the specific period is prior to a power-off period.

13. The method of claim 9, further comprising:
during the power-off period, allowing the data electrode and the common electrode to enter a high impedance state, respectively.
